(19) United States
(12) Patent Application Publication
(10) Pub. No.: US 2020/0302359 A1
(43) Pub. Date: Sep. 24, 2020

(54) METHOD AND SYSTEM FOR DETERMINING A POTENTIAL SUPPLIER FOR A PROJECT

(71) Applicant: Wipro Limited, Bangalore (IN)

(72) Inventors: Juby Jose, Bangalore (IN); Roman Kuzmik, Naperville, IL (US)

(21) Appl. No.: 16/362,251

(22) Filed: Mar. 22, 2019

(51) Int. Cl. G06Q 10/06; G06N 5/04; G06N 5/02; G06Q 10/08; G06F 16/36; G06F 16/38; G06F 16/33

(52) U.S. Cl. CPC G06Q 10/06313; G06N 5/04; G06N 5/02; G06F 16/3334; G06F 16/367; G06F 16/38; G06Q 10/08

(57) ABSTRACT

The present disclosure is related to field of data analytics and machine learning, disclosing method and system for determining a potential supplier for a project. Supplier determining system extracts entities and qualifying phrases corresponding to entities from input data using predefined ontology related to domain of the project. Subsequently, the supplier determining system generates data models by annotating each qualifying phrase corresponding to the entities with a label and further, generates weighted knowledge graph corresponding to each data model that correlates suppliers, entities and assessing attributes of the suppliers, wherein weightage may be determined based on each label to indicate degree of correlation. Finally, the supplier determining system may recommend a potential supplier by ranking each supplier based on requirements queried by a user for the project and based on the degree of correlation. The present disclosure is adaptable to any domain of the project for determining a potential supplier.

### FIELD

The present subject matter is related in general to the field of data analytics and machine learning, and more particularly, but not exclusively to a method and a system determining a potential supplier for a project.

### BACKGROUND

Generally, shortlisting and selecting potential suppliers for developing a project is crucial for an organization. In order to shortlist and select the potential suppliers, majorly, the organization performs systematic assessment of suppliers' assets and capabilities, determination of project activities to engage in with different suppliers, planning and execution of interactions with the suppliers in a coordinated fashion across a supplier relationship life cycle.

However, performing the abovementioned activities is a complex task which would involve substantive involvement of manual efforts. Complexity and the manual efforts may be directly proportional to number of the suppliers in market, which leads to delay in shortlisting and selecting the potential suppliers. As an example, a project could be related to manufacturing a car. For this project, the suppliers could supply various services or components like tyres, infotainment system, electric control system, safety system, raw materials, electronic components, mechanical components, batteries, engine, transmission system, accessories, and the like. Each of the suppliers may be capable of supplying one or more of these services or components.

Existing techniques provide methods for comparison of the information related to the suppliers, however, the comparison may be based on tender prices offered by the suppliers. Therefore, the existing techniques may lose visibility in accordance with various other parameters that are crucial for determining the potential suppliers. Further, in some scenarios, information related to the suppliers that is available for performing the systematic assessment of the suppliers may be incomplete, which may lead to drawing incorrect inferences regarding suitability of the suppliers for the project.

### SUMMARY

One or more shortcomings of the prior art are overcome, and additional advantages are provided through the present disclosure. Additional features and advantages are realized through the techniques of the present disclosure. Other embodiments and aspects of the disclosure are described in detail herein and are considered a part of the claimed disclosure.

Disclosed herein is a method of determining a potential supplier for a project. The method includes receiving, by a supplier determining system, input data related to a plurality of suppliers from one or more data sources associated with the supplier determining system, wherein the plurality of suppliers are related to a domain of a project. Upon receiving the input data, the method includes extracting one or more entities and qualifying phrases corresponding to the one or more entities from the input data using a predefined ontology related to the domain. Further, the method includes generating one or more data models by annotating each of the qualifying phrases corresponding to the one or more entities with a label. Furthermore, the method includes generating a weighted knowledge graph corresponding to each of the one or more data models that correlates the plurality of suppliers, the one or more entities and assessing attributes of the plurality of suppliers. Weightage in the weighted knowledge graph is determined based on each label to indicate a degree of correlation. Finally, the method includes recommending a potential supplier from the plurality of suppliers by ranking each of the plurality of suppliers based on one or more requirements queried by a user for the project and based on the degree of correlation inferred from each weighted knowledge graph.

Further, the present disclosure comprises a supplier determining system for determining a potential supplier for a project. The supplier determining system comprises a processor and a memory communicatively coupled to the processor. The memory stores the processor-executable instructions, which, on execution, causes the processor to receive input data related to a plurality of suppliers from one or more data sources associated with the supplier determining system. The plurality of suppliers is related to a domain of a project. Upon receiving the input data, the processor extracts one or more entities and qualifying phrases corresponding to the one or more entities from the input data using a predefined ontology related to the domain. Further, the processor generates one or more data models by annotating each qualifying phrase corresponding to the one or more entities with a label. Furthermore, the processor generates a weighted knowledge graph corresponding to each of the one or more data models that correlates the plurality of suppliers, the one or more entities and assessing attributes of the plurality of suppliers. Weightage in the weighted knowledge graph is determined based on each label to indicate a degree of correlation. Finally, the processor recommends a potential supplier from the plurality of suppliers by ranking each of the plurality of suppliers based on one or more requirements queried by a user for the project and based on the degree of correlation inferred from each weighted knowledge graph.

Furthermore, the present disclosure comprises a non-transitory computer readable medium including instructions stored thereon that when processed by at least one processor causes a supplier determining system to perform operations comprising receiving input data related to a plurality of suppliers from one or more data sources associated with the supplier determining system. The plurality of suppliers are related to a domain of a project. Further, the instructions cause the processor to extract one or more entities and qualifying phrases corresponding to the one or more entities from the input data using a predefined ontology related to the domain. Subsequently, the instructions cause the processor to generate one or more data models by annotating each of the qualifying phrases corresponding to the one or more entities with a label. Furthermore, the instructions cause the processor to generate a weighted knowledge graph corresponding to each of the one or more data models that correlates the plurality of suppliers, the one or more entities and assessing attributes of the plurality of suppliers. Weightage in the weighted knowledge graph is determined based on each label to indicate a degree of correlation. Finally, the instructions cause the processor to recommend a potential supplier from the plurality of suppliers by ranking each of the plurality of suppliers based on one or more requirements queried by a user for the project and based on the degree of correlation inferred from each weighted knowledge graph.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 shows an exemplary architecture for determining a potential supplier for a project in accordance with some embodiments of the present disclosure;

FIG. 2A shows a detailed block diagram of a supplier determining system for determining a potential supplier for a project in accordance with some embodiments of the present disclosure;

FIG. 2B shows an exemplary knowledge graph in accordance with some embodiments of the present disclosure;

FIG. 3 shows a flowchart illustrating a method of determining a potential supplier for a project in accordance with some embodiments of the present disclosure; and

FIG. 4 is a block diagram of an exemplary computer system for implementing embodiments consistent with the present disclosure.

It should be appreciated by those skilled in the art that any block diagram herein represents conceptual views of illustrative systems embodying the principles of the present subject matter. Similarly, it will be appreciated that any flow chart, flow diagram, state transition diagram, pseudo code, and the like represent various processes which may be substantially represented in computer readable medium and executed by a computer or a processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternatives falling within the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

The present disclosure provides a method and a system for determining a potential supplier for a project. In some embodiments, the potential supplier may be determined from a plurality of suppliers related to a domain of the project. A supplier determining system may receive input data related to the plurality of suppliers from one or more data sources associated with the supplier determining system. In some embodiments, the input data may include data related to capabilities, strengths, weaknesses, experience and the like, that provide an overall picture of the plurality of suppliers. Upon receiving the input data, the supplier determining system may extract one or more entities and qualifying phrases corresponding to the one or more entities from the input data using a predefined ontology related to the domain. Further, the supplier determining system may generate one or more data models by annotating each of the qualifying phrases corresponding to the one or more entities with a label. As an example, the label annotated to each of the qualifying phrases may include, but not limited to, excellent, good, Satisfactory or Bad. The supplier determining system may subsequently generate a weighted knowledge graph corresponding to each of the one or more data models that correlates the plurality of suppliers, the one or more entities and assessing attributes of the plurality of suppliers. In some embodiments, weightage in the weighted knowledge graph may be determined based on each label to indicate a degree of correlation. Further, the supplier determining system may rank each of the plurality of suppliers based on one or more requirements queried by a user for the project. The supplier determining system may recommend a potential supplier from the plurality of suppliers based on the ranking and the degree of correlation inferred from each weighted knowledge graph.

The present disclosure selects the predefined ontology to extract the one or more entities and qualifying phrases from the input data based on domain of the project. Therefore, the present disclosure has the technical advantage of adapting to any domain of the project for determining a potential supplier. Further, the present disclosure considers input data from internal sources and external sources. The internal sources are from within the organization to which the project belongs, hence providing reliable data based on previous experiences with the plurality of suppliers. Further, the external sources provide additional information related to the plurality of suppliers that is available publicly. The input data retrieved from internal and external sources provide abundance of information about the plurality of suppliers to generate accurate recommendations. Further, the present disclosure is completely automated i.e. based on the input data, the supplier determining system automatically extracts one or more entities and qualifying phrases, generates one or more data models and weighted knowledge graphs, analyses requirement of the users and recommends a potential supplier from the plurality of suppliers by ranking each of the plurality of suppliers based on the requirements. The present disclosure performs each of the aforesaid actions using pre-trained machine learning techniques, which completely eliminates involvement of manual efforts, thereby reducing the complexity, time and resources involved in determining the potential supplier for the project. Further, the weighted knowledge graphs created in the present disclosure establishes strong association between the plurality of suppliers, entities and assessing attributes, which enhances flexibility in accepting and processing various forms of queries from the users.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

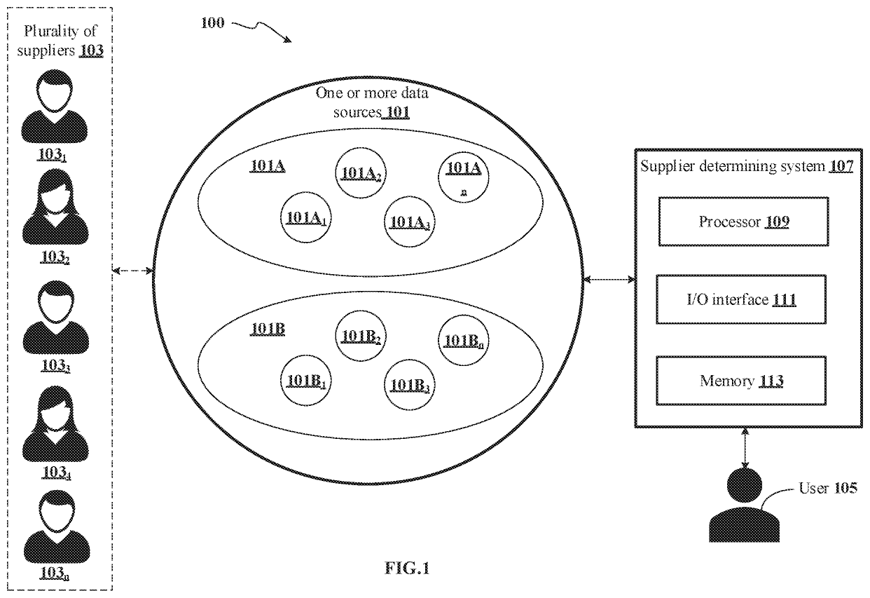

FIG. 1 shows an exemplary architecture for determining a potential supplier for a project in accordance with some embodiments of the present disclosure.

The architecture 100 includes one or more data sources 101, supplier 103₁ to 103ₙ (also referred as plurality of suppliers 103), a user 105 and a supplier determining system 107. In some embodiments, the one or more data sources 101 may include, but not limited to, internal data sources 101A₁ to 101Aₙ (also referred as internal data sources 101A) and external data sources 101B₁ to 101Bₙ (also referred as external data sources 101B). In some embodiments, the internal data sources 101A may be sources from within an organization that requires determination of a potential supplier for developing a project. In some embodiments, the external data sources 101B may be sources from outside the organization. The internal data sources 101A and the external data sources 101B may include data related to the plurality of suppliers 103. As an example, the internal data sources 101A may include, but not limited to, site visit reports, previous experience of working with the plurality of suppliers 103, feedback of employees on work quality of the plurality of suppliers 103 and tenders received from the plurality of suppliers 103. As an example, the external data sources 101B may include, but not limited to, forums, articles, publications, online magazines and newspapers, and websites of the plurality of suppliers 103. In some embodiments, the one or more data sources 101 may communicate with the supplier determining system 107 via a communication network (not shown in the FIG. 1). As an example, the communication network may be at least one of a wired communication network and a wireless communication network.

In some embodiments, the plurality of suppliers 103 may be related to a domain of the project. As an example, if the domain of the project is related to data analytics, the plurality of suppliers 103 may be the suppliers who provide services related to data analytics. As an example, the user 105 may be personnel from the organization, a consumer or a customer associated with the supplier determining system 107, to provide one or more requirements in the form of a query to the supplier determining system 107. In some embodiments, the supplier determining system 107 may provide recommendations to the user 105 based on the one or more requirements queried by the user 105.

The supplier determining system 107 may include a processor 109, an Input/Output (I/O) interface 111 and a memory 113. The I/O interface 111 may receive input data related to the plurality of suppliers 103 from the one or more data sources 101 via the communication network. As an example, the input data may include data related to capabilities, strengths, weaknesses, experience and the like, that provide an overall picture of the plurality of suppliers 103. Further, the I/O interface 111 may also be configured to receive the one or more requirements queried by the user 105.

Upon receiving the input data, the processor 109 may extract one or more entities and qualifying phrases corresponding to the one or more entities from the input data using a predefined ontology related to the domain. As an example, if the domain is related to aircrafts, the predefined ontology may include, entities, parameters, concepts and categories related to aircrafts and also provides relationships between each of the entities, concepts and categories. Further, the processor 109 may generate one or more data models by annotating each of the qualifying phrases corresponding to the one or more entities with a label. As an example, the label annotated to each of the qualifying phrases may include, but not limited to, excellent, good, Satisfactory or Bad. The processor 109 may subsequently generate a weighted knowledge graph corresponding to each of the one or more data models that correlates the plurality of suppliers, the one or more entities and assessing attributes of the plurality of suppliers 103. In some embodiments, weightage in the weighted knowledge graph may be determined based on each annotated label to indicate a degree of correlation. As an example, the assessing attributes of the plurality of suppliers 103 may include, but not limited to, capabilities of the plurality of suppliers 103, experience of the plurality of suppliers 103, location of the plurality of suppliers 103, previous engagements of the plurality of suppliers 103, strengths, weaknesses and risks of the plurality of suppliers 103, market reputation of the plurality of suppliers 103, expertise of the plurality of suppliers 103, infrastructure details of the plurality of suppliers 103 and team size of the plurality of suppliers 103. Further, the processor 109 may rank each of the plurality of suppliers 103 based on the one or more requirements queried by the user 105 for the project. Based on the ranking, the processor 109 may recommend the potential supplier from the plurality of suppliers 103 based on the ranking and the degree of correlation inferred from each weighted knowledge graph.

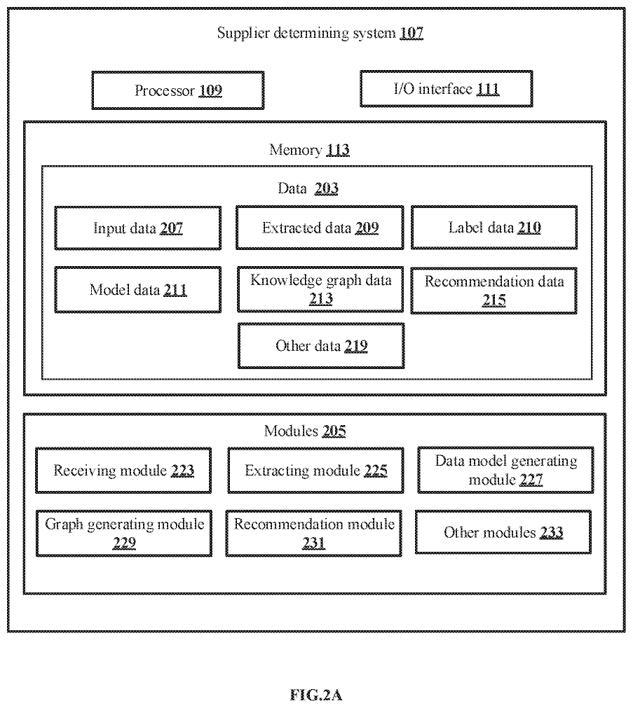

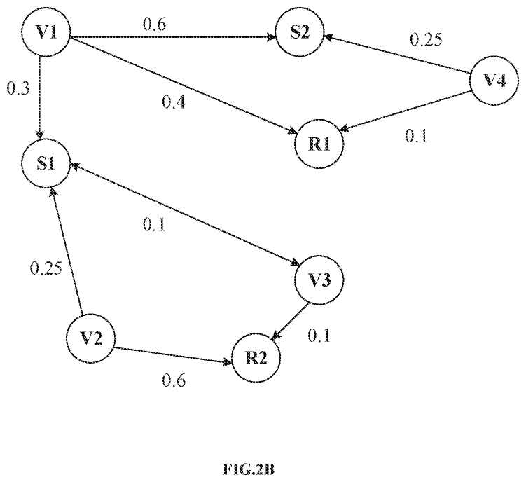

FIG. 2A shows a detailed block diagram of a supplier determining system for determining a potential supplier for a project in accordance with some embodiments of the present disclosure.

In some implementations, the supplier determining system 107 may include data 203 and modules 205. As an example, the data 203 may be stored in a memory 113 configured in the supplier determining system 107 as shown in the FIG. 2A. In one embodiment, the data 203 may include input data 207, extracted data 209, label data 210, model data 211, knowledge graph data 213, recommendation data 215 and other data 219. In the illustrated FIG. 2A, modules 205 are described herein in detail.

In some embodiments, the data 203 may be stored in the memory 113 in form of various data structures. Additionally, the data 203 can be organized using data models, such as relational or hierarchical data models. The other data 219 may store data, including temporary data and temporary files, generated by the modules 205 for performing the various functions of the supplier determining system 107.

In some embodiments, the data 203 stored in the memory 113 may be processed by the modules 205 of the supplier determining system 107. The modules 205 may be stored within the memory 113. In an example, the modules 205 communicatively coupled to the processor 109 configured in the supplier determining system 107, may also be present outside the memory 113 as shown in FIG. 2A and implemented as hardware. As used herein, the term modules 205 may refer to an application specific integrated circuit (ASIC), an electronic circuit, a processor (shared, dedicated, or group) and memory that execute one or more software or firmware programs, a combinational logic circuit, and/or other suitable components that provide the described functionality.

In some embodiments, the modules 205 may include, for example, a receiving module 223, an extracting module 225, a data model generating module 227, a graph generating module 229, a recommendation module 231 and other modules 233. The other modules 233 may be used to perform various miscellaneous functionalities of the supplier determining system 107. It will be appreciated that such aforementioned modules 205 may be represented as a single module or a combination of different modules.

In some embodiments, the receiving module 223 may receive the input data 207 related to a plurality of suppliers 103 from one or more data sources 101 associated with the supplier determining system 107. In some embodiments, the input data 207 may include data related to capabilities, strengths, weaknesses, experience and the like that provide an overall picture of the plurality of suppliers 103. In some embodiments, the input data 207 may be in any data format that may include, but not limited to, Power Point slides, excel sheets, WL, PDF and a word document. In some embodiments, the input data 207 received from the one or more data sources 101 may be unstructured and un-annotated. Further, the one or more data sources 101 may include, but not limited to, internal data sources 101A and external data sources 101B. In some embodiments, the internal data sources 101A may be sources present within an organization that requires determination of a potential supplier for developing a project. In some embodiments, the external data sources 101B may be sources present outside the organization. The internal data sources 101A and the external data sources 101B may pertain data related to the plurality of suppliers 103. As an example, the internal data sources 101A may include, but not limited to, site visit reports, previous experience of working with the plurality of suppliers 103, feedback of employees on work quality of the plurality of suppliers 103 and tenders received from the plurality of suppliers 103. As an example, the external data sources 101B may include, but not limited to, forums, articles, publications, online magazines and newspapers, and websites of the plurality of suppliers 103. In some embodiments, the input data 207 received from the internal data sources 101A may be utilized for training machine learning techniques. In some embodiments, receiving module 223 may receive the input data 207 in real-time, as and when at least one of the internal data sources 101A and the external data sources 101B are updated with new information related to the plurality of suppliers 103 related to the domain of the project.

Further, the extracting module 225 may extract one or more entities and qualifying phrases corresponding to the one or more entities from the input data 207 using a predefined ontology related to a domain of the project. Initially, the extracting module 225 may normalize and structure the input data 207 using predefined techniques. As an example, the predefined techniques may include, but not limited to, Natural Language Processing (NLP) techniques. As an example, the NLP techniques may be machine learning techniques that are pre-trained to perform conversion, structuring and normalization of the input data 207, Named Entity Recognition (NER), classification and tagging of the input data 207. Upon structuring and normalizing the input data 207, the extracting module 225 may select the predefined ontology related to the domain based on the input data 207. As an example, if the domain is related to aircrafts, the predefined ontology may include, entities, parameters, concepts and categories related to aircrafts, and relationship between each of the entities, concepts and categories. Further, the extracting module 225 may extract the one or more entities and qualifying phrases corresponding to the one or more entities based on the predefined ontology. As an example, consider an exemplary statement “Supplier A has 7 years of experience and are experts in manufacturing landing gears”. In the above exemplary statement, for a subject “Supplier A”, entity may be “landing gears” and qualifying phrases corresponding to the entity may be “7 years experience” and “experts in manufacturing”. As an example, consider another exemplary statement “Supplier B is a new start-up that manufactures inner cabinets of aircrafts and have poor HR process”. In the above exemplary statements, for a subject “Supplier B”, entities extracted may be “manufacture” and “HR process”. The qualifying phrase corresponding to the extracted entity “manufacture” may be “inner cabinets of aircrafts”, and qualifying phrase corresponding to the extracted entity “HR process” may be “new start-up” and “poor HR process”. The one or more entities and the qualifying phrases corresponding to the one or more entities may be stored as the extracted data 209. In some embodiments, each of the one or more entities may be classified into one or more predefined categories. In some embodiments, exemplary entities such as “Aircraft maintenance” and “Aircraft repair” may be categorized into an exemplary category such as “Fleet support”. In some other embodiments, exemplary entity such as “qualification and acceptance testing” may be categorized into an exemplary category such as “Load test and validation”.

Further, the data model generating module 227 may generate one or more data models using machine learning techniques that are pre-trained based on the input data 207, and the one or more entities and the qualifying phrases extracted from the input data 207. In some embodiments, initially, the data model generating module 227 may annotate each of the qualifying phrases extracted by the extracting module 225 with a label. The label assigned to each of the qualifying phrases may indicate quality of each of the qualifying phrases. As an example, the label may include, but not limited to, excellent, good, Satisfactory or Bad. In another example, the label may include, but not limited to, high, medium and low. In some embodiments, the data model generating module 227 may use labelling functions designed for big datasets for training the machine learning techniques. The label assigned to each of the qualifying phrases may be stored as the label data 210. When the data model generating module 227 makes a labelling decision, a natural language description provided for each such labelling decision may develop a weak supervised classifier. Further, intelligent semantic parser associated with the data model generating module 227 may convert the natural language description into programmatic labelling functions that in turn generate labels for each of the qualifying phrases.

Further, the data model generating module 227 may generate the one or more data models based on the label annotated to each of the qualifying phrases corresponding to the one or more entities, using the machine learning techniques. In some embodiments, the one or more data models, provide structured data including categorized entities, qualifying phrases corresponding to the categorized entities, label annotated to each of the qualifying phrases and corresponding relationships. The one or more data models thus generated may be stored as the model data 211. In some embodiments, when the receiving module 223 receives input data 207 which is updated in at least one of the internal data sources 101A and the external data sources 101B, the data model generating module 227 may update the one or more data models based on the updated input data. In some embodiments, the machine learning techniques may further use the updated input data to enhance data used by the machine learning techniques for the purpose of self-learning.

Further, the graph generating module 229 may generate a weighted knowledge graph corresponding to each of the one or more data models by correlating the plurality of suppliers 103, the one or more entities and assessing attributes of the plurality of suppliers 103 based on the one or more data models. As an example, the assessing attributes of the plurality of suppliers 103 may include, but not limited to, capabilities of the plurality of suppliers 103, experience of the plurality of suppliers 103, location of the plurality of suppliers 103, previous engagements of the plurality of suppliers 103, strengths, weaknesses and risks of the plurality of suppliers 103, market reputation of the plurality of suppliers 103, expertise of the plurality of suppliers 103, infrastructure details of the plurality of suppliers 103 and team size of the plurality of suppliers 103. In some embodiments, the weighted knowledge graph provides a holistic relationship structure between the plurality of suppliers 103, the one or more entities and the assessing attributes of the plurality of suppliers 103. Further, the processor 109 may predict progress of the plurality of suppliers 103 based on the input data 207 and the weighted knowledge graphs corresponding to each of the plurality of suppliers 103. In some embodiments, the processor 109 may perform predict the progress based on the machine learning techniques such as the Natural Language Understanding (NLU) models that may be custom trained Long Short-Term Memory (LSTM) models.

Further, each link in the weighted knowledge graph may be associated with a corresponding weightage that denotes degree of correlation between the plurality of suppliers 103, the one or more entities and the assessing attributes of the plurality of suppliers 103. In some embodiments, the weightage may also provide a comparison between multitude of suppliers 103 while traversing through the weighted knowledge graph, i.e. the weighted knowledge graph enables performing a comparison between the plurality of suppliers 103 based on the assessing attributes. In some embodiments, the weightage may be assigned to each link in the weighted knowledge graph based on the label annotated to each of the qualifying phrases. In an exemplary embodiment, when the label associated with the qualifying phrases is high, the weightage corresponding to the label may be 3. Similarly, when the label associated with the qualifying phrases is medium, the weightage corresponding to the label may be 2 and when the label associated with the qualifying phrases is low, the weightage corresponding to the label may be 1. In another exemplary embodiment, when the label is Excellent, the weightage may be 10, when the label is good, the weightage may be 5, when the label is satisfactory, the weightage may be 3, and when the label is bad, the weightage may be 0. In general, the weightage assigned to each label may be directly proportional to the quality of the qualifying phrase denoted by the label. In some embodiments, the weightage corresponding to each label may be predefined. An exemplary knowledge graph is shown in FIG. 2B. In the exemplary knowledge graph, nodes V1, V2, V3 and V4 denote exemplary suppliers, nodes S1 and S2 denote strengths considered for comparing the suppliers V1, V2, V3 and V4, and nodes R1 and R2 denote risks considered for comparing the suppliers V1, V2, V3 and V4. In some embodiments, value associated with each directed edge in the exemplary knowledge graph denotes a correlation of the vendor with the corresponding assessing attribute such as strength and risk as shown in the FIG. 2B. In some embodiments, the value associated with each directed edge in the exemplary knowledge graph may be a static value. The static value may be varied dynamically based on one or more requirements of a user 105, since weightage associated with each assessing attribute may vary based on the one or more requirements. The weighted knowledge graph generated for each of the one or more data models and the corresponding weightage may be stored as the knowledge graph data 213.

Further, the recommendation module 231 may recommend a potential supplier from the plurality of suppliers 103 by ranking each of the plurality of suppliers 103. In some embodiments, the recommendation module 231 may rank each of the plurality of suppliers 103 based on the one or more requirements queried by the user 105 for the project and based on the degree of correlation inferred from the weighted knowledge graphs. As an example, the user 105 may be personnel from the organization, a consumer or a customer associated with the supplier determining system 107, to provide one or more requirements in the form of a query to the supplier determining system 107. In some embodiments, initially, the recommendation module 231 may receive one or more requirements from the user 105 via I/O interface 111 of the supplier determining system 107. Further, upon receiving the one or more requirements queried by the user 105, the recommendation module 231 may retrieve required data corresponding to the one or more requirements from the knowledge graph data 213, that provides the correlation and the degree of correlation. Further, the recommendation module 231 may rank the plurality of suppliers 103 based on the one or more requirements of the user 105 and based on the degree of correlation inferred from the corresponding weighted knowledge graph.

In some embodiments, the recommendation module 231 may rank the plurality of suppliers 103 using the below Equation 1.

R(V₁)=(1−λ)/N+λ(sum the assessing attributes) Equation 1

In the above Equation 1,
R(V1) denotes rank of supplier 1 denoted by V₁;
λ denotes a damping factor which may be set between 0 to 1; and
N denotes number of suppliers selected for ranking.

As an example, value of the damping factor (λ) may be in a range of 0.25-0.85. Further, in the above Equation 1, consider one of the assessing attributes is strength of the supplier. In an exemplary embodiment, the recommendation module 231 may determine strength of supplier 1 [Strength(V₁)] using the below Equation 2.

Strength(V₁)=ΣS(V₁/Vⱼ)/C(Sj) Equation 2

In the above Equation 2,
V₁ denotes supplier 1;
Vj denotes supplier j;
Strength (V₁) denotes strength of supplier 1; and
C denotes count of the plurality of suppliers 103 having strength Sj.

Further, in the above Equation 1, consider another assessing attribute is risk of the supplier. In an exemplary embodiment, the recommendation module 231 may determine risk of supplier 1 [Risk(V₁)] using the below Equation 3.

Risk(V₁)=ΣR(V₁/Vⱼ)/C(V^{Rj}) Equation 3

In the above Equation 3,
V₁ denotes supplier 1;
Vj denotes supplier j; and
C denotes count of the plurality of suppliers 103 selected for comparison based on user query;
C(V^{Rj}) denotes count of suppliers selected for risk comparisons; and
R denotes risk associated with V₁ compared with other suppliers.

Similarly, the recommendation module 231 may determine each of the assessing attributes to be used in Equation 1.

Based on the rank assigned to each of the plurality of suppliers 103, the recommendation module 231 may recommend a supplier among the plurality of suppliers 103, that best matches the one or more requirements of the user 105, as the potential supplier for developing the project. In an exemplary embodiment, the supplier assigned with the least rank i.e. supplier assigned with a rank 1, may be determined as the potential supplier for developing the project. In another exemplary embodiment, predefined number of suppliers assigned with least ranks may be determined as potential suppliers for developing the project. As an example, suppliers assigned with least 3 ranks, i.e. ranks 1, 2 and 3 may be determined as potential suppliers. The organization may subsequently select a suitable supplier from the determined potential suppliers. The one or more recommendations provided by the recommendation module 231 may be stored as the recommendation data 215. In some embodiments, the recommendation module 231 may dynamically vary the rank associated with each of the plurality of suppliers 103 based on changes in the one or more requirements queried by the user 105. In some embodiments, such ranking and comparison may provide a comprehensive view of various aspects related to the plurality of suppliers 103, to the user 105, thereby facilitating decision making process regarding the potential supplier for developing the project.

Henceforth, the process of determining a potential supplier for a project is explained with the help of one or more examples for better understanding of the present disclosure. However, the one or more examples should not be considered as a limitation of the present disclosure.

Consider an exemplary scenario with the following exemplary details:
Domain: Aircraft
Project: Manufacturing landing gears for an Aircraft
Organization: Company “XYZ”
Plurality of suppliers: Suppliers involved in Aircraft manufacturing—Supplier 1, Supplier 2, Supplier 3 and Supplier 4.
User: Employee of the organization
One or more requirements:
   Requirement 1: Suppliers who manufacture landing gears for an Aircraft; and
   Requirement 2: Suppliers who are minimum 3 years experienced

Upon receiving the input data from the one or more data sources 101, the processor 109 may extract one or more entities and qualifying phrases corresponding to the one or more entities. Further, the processor 109 may assign a label and corresponding weightage to each of the qualifying phrases based on the below table:

| Label | Weightage |
|---|---|
| Excellent | 5 |
| Good | 2 |
| Bad | 0 |

1. Input data: Supplier 1 is in Aircraft manufacturing business from 10 years but has 4 failed projects.
   Subject: Supplier 1
   Entity: Manufacturing
   Qualifying phrases: “10 years” and “4 failed projects”
   Label: Bad
   Weightage: 0
2. Supplier 2 has entered the manufacturing industry 1 year ago and has one ongoing project.
   Subject: Supplier 2
   Entities: Manufacturing
   Qualifying phrases: “1 year ago” and “one ongoing project”
   Label: Bad
   Weightage: 0
3. Supplier 3 has expertise in manufacturing landing gears and has successfully completed 7 projects in a span of 5 years. ABC company has invested 50 crores on supplier 3.
   Subject: Supplier 3
   Entities: Manufacturing
   Qualifying phrases: “landing gears”, “successfully completed”, “7 projects”, “5 years”, “investment 50 crores”
   Label: Excellent
   Weightage: 5
4. Supplier 4 manufactures landing gears and established company two years ago and has 1 failed project and 1 ongoing project.
Subject: Supplier 4
Entities: Manufacturing
Qualifying phrases: “landing gears”, “established company two years ago”, “1 failed project” and “1 ongoing project”
Label: Bad
Weightage: 0

Based on the above extracted entities and the qualifying phrases, the processor 109 may generate one or more data models by assigning the abovementioned labels. Further, the processor 109 may generate a weighted knowledge graph based on the one or more data models that correlates the suppliers 1, 2, 3 and 4, the one or more entities and assessing attributes of the suppliers 1, 2, 3 and 4. The weightage may be assigned to each link in the weighted knowledge graph to indicate degree of correlation based on the labels assigned to each of the qualifying phrases. Further, the processor 109 may rank the suppliers 1, 2, 3 and 4 based on the one or more requirements queried by the user for the project and based on the degree of correlation inferred from each weighted knowledge graph.

As an example, consider rank assigned to the suppliers is as shown below.
Supplier 3—Rank 1
Supplier 1—Rank 4
Supplier 2—Rank 2
Supplier 4—Rank 3

Therefore, based on the above ranking, the processor 109 may recommend supplier 3 as the potential supplier for the project, in view of the one or more requirements of the user. Further, the processor 109 may predict that, the supplier 3 may be acquired by company ABC, which is analysed based on the investment details mentioned in the input data.

In another exemplary scenario, consider the exemplary knowledge graph as shown in the FIG. 2B. As shown in the exemplary knowledge graph, Strength S1 of supplier V1 is 0.3, Strength S1 of supplier V2 is 0.25, Strength S1 of supplier V3 is 0.1. Similarly, Risk R1 of supplier V1 is 0.4, Risk R2 of supplier V2 is 0.6 and Risk R2 of supplier V3 is 0.1.

Consider, user queries for a potential vendor having Strength S1 with least risk involved. The graph generating module 229 may assign a weightage for each supplier dynamically with respect to the user query. As an example, consider the graph generating module 229 assigns a weightage of 3 to Strength S1 of supplier V1, weightage of 2 to Strength S1 of supplier V2 and weightage of 1 to Strength S1 of supplier V3. Further, since supplier 4 does not possess the strength S1, the processor 109 may not consider supplier 4 for determining the potential supplier for the user 105.

By using the Equation 2, consider exemplary strength S1 of suppliers V1, V2 and V3 which are determined dynamically based on the weight assigned to the suppliers V1, V2 and V3 is 0.8, 0.5 and 0.3 respectively. Similarly, the graph generating module 229 may determine Risk R1 associated with supplier V1, Risk R2 associated with supplier V2 and Risk R3 associated with supplier V3, using the Equation 3. Consider exemplary risk associated with suppliers R1, R2 and R3 is 0.1, 0.4 and 0.5 respectively.

Further, the recommendation module 231 may determine rank of each of the suppliers V1, V2 and V3 based on their strength S1 and Risks R1, R2. By substituting the values of S1 and R1, R2 associated with supplier V1, V2 and V3 respectively in Equation 1, consider the rank of the suppliers is determined is as shown below:
Rank 1—Supplier V1
Rank 2—Supplier V3
Rank 3—Supplier V2

Therefore, based on the ranks determined, the recommendation module 231 may recommend Supplier V1 as the potential supplier for the user 105. In some embodiments, the ranks assigned to the suppliers may dynamically vary based on query of the user 105 which indicates various requirements of the user 105.

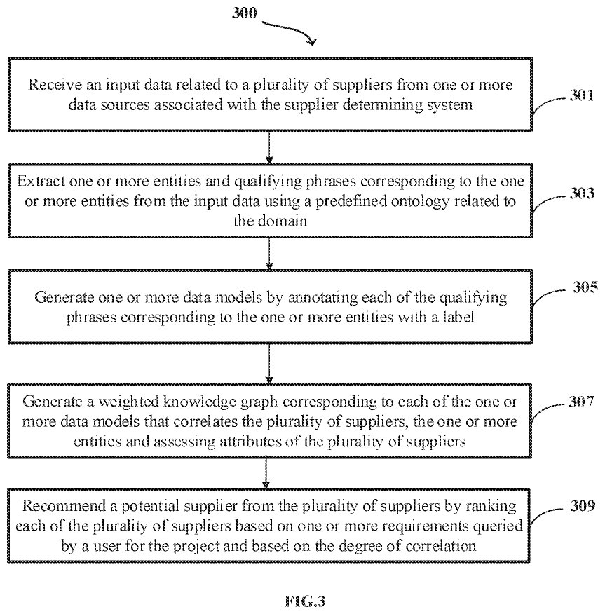

FIG. 3 shows a flowchart illustrating a method of determining a potential supplier for a project in accordance with some embodiments of the present disclosure.

As illustrated in FIG. 3, the method 300 includes one or more blocks illustrating a method of determining a potential supplier for a project. The method 300 may be described in the general context of computer-executable instructions. Generally, computer-executable instructions can include routines, programs, objects, components, data structures, procedures, modules, and functions, which perform functions or implement abstract data types.

The order in which the method 300 is described is not intended to be construed as a limitation, and any number of the described method blocks can be combined in any order to implement the method 300. Additionally, individual blocks may be deleted from the methods without departing from the spirit and scope of the subject matter described herein. Furthermore, the method 300 can be implemented in any suitable hardware, software, firmware, or combination thereof.

At block 301, the method 300 may include receiving, by a processor 109 of the supplier determining system 107, input data 207 related to a plurality of suppliers 103 from one or more data sources 101 associated with the supplier determining system 107. In some embodiments, the plurality of suppliers 103 may be related to a domain of a project.

At block 303, the method 300 may include extracting, by the processor 109, one or more entities and qualifying phrases corresponding to the one or more entities from the input data 207 using a predefined ontology related to the domain.

At block 305, the method 300 may include generating, by the processor 109, one or more data models by annotating each of the qualifying phrases corresponding to the one or more entities with a label. As an example, the label annotated to each of the qualifying phrases may include, but not limited to, Excellent, Good, Satisfactory or Bad.

At block 307, the method 300 may include generating, by the processor 109, a weighted knowledge graph corresponding to each of the one or more data models that correlates the plurality of suppliers 103, the one or more entities and assessing attributes of the plurality of suppliers 103. In some embodiments, weightage associated with each link in the weighted knowledge graph may be determined based on each label to indicate a degree of correlation.

At block 309, the method 300 may include recommending, by the processor 109, a potential supplier from the plurality of suppliers 103 by ranking each of the plurality of suppliers 103 based on one or more requirements queried by a user 105 for the project and based on the degree of correlation inferred from the weighted knowledge graphs. As an example, the user 105 may be personnel from an organization that requires the potential supplier for developing the project, a consumer or a customer associated with the supplier determining system 107 and the like to provide one or more requirements in the form of a query to the supplier determining system 107. In some embodiments, the processor 109 may predict progress of the plurality of suppliers 103 based on the input data 207 and the weighted knowledge graphs corresponding to each of the plurality of suppliers 103 and may also provide recommendations based on the prediction.

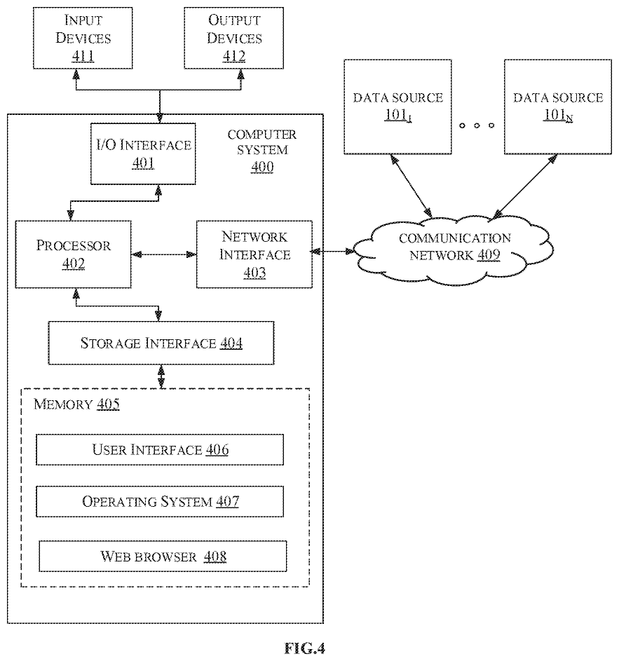

FIG. 4 is a block diagram of an exemplary computer system for implementing embodiments consistent with the present disclosure.

In some embodiments, FIG. 4 illustrates a block diagram of an exemplary computer system 400 for implementing embodiments consistent with the present invention. In some embodiments, the computer system 400 can be supplier determining system 107 that is used for determining a potential supplier for a project. The computer system 400 may include a central processing unit (“CPU” or “processor”) 402. The processor 402 may include at least one data processor for executing program components for executing user or system-generated business processes. A user may include a person, a person using a device such as those included in this invention, or such a device itself. The processor 402 may include specialized processing units such as integrated system (bus) controllers, memory management control units, floating point units, graphics processing units, digital signal processing units, etc.

The processor 402 may be disposed in communication with input devices 411 and output devices 412 via I/O interface 401. The I/O interface 401 may employ communication protocols/methods such as, without limitation, audio, analog, digital, stereo, IEEE-1394, serial bus, Universal Serial Bus (USB), infrared, PS/2, BNC, coaxial, component, composite, Digital Visual Interface (DVI), high-definition multimedia interface (HDMI), Radio Frequency (RF) antennas, S-Video, Video Graphics Array (VGA), IEEE 802.n/b/g/n/x, Bluetooth, cellular (e.g., Code-Division Multiple Access (CDMA), High-Speed Packet Access (HSPA+), Global System For Mobile Communications (GSM), Long-Term Evolution (LTE), WiMax, or the like), etc.

Using the I/O interface 401, the computer system 400 may communicate with the input devices 411 and the output devices 412.

In some embodiments, the processor 402 may be disposed in communication with a communication network 409 via a network interface 403. The network interface 403 may communicate with the communication network 409. The network interface 403 may employ connection protocols including, without limitation, direct connect, Ethernet (e.g., twisted pair 10/100/1000 Base T), Transmission Control Protocol/Internet Protocol (TCP/IP), token ring, IEEE 802.11a/b/g/n/x, etc. Using the network interface 403 and the communication network 409, the computer system 400 may communicate with one or more data sources 101 that may include, but not limited to, internal data sources 101A (101A₁ to 101Aₙ) and external data sources 101B (101B₁ to 101Bₙ). The communication network 409 can be implemented as one of the different types of networks, such as intranet or Local Area Network (LAN), Closed Area Network (CAN) and such. The communication network 409 may either be a dedicated network or a shared network, which represents an association of the different types of networks that use a variety of protocols, for example, Hypertext Transfer Protocol (HTTP), CAN Protocol, Transmission Control Protocol/Internet Protocol (TCP/IP), Wireless Application Protocol (WAP), etc., to communicate with each other. Further, the communication network 409 may include a variety of network devices, including routers, bridges, servers, computing devices, storage devices, etc. In some embodiments, the processor 402 may be disposed in communication with a memory 405 (e.g., RAM, ROM, etc. not shown in FIG. 4) via a storage interface 404. The storage interface 404 may connect to memory 405 including, without limitation, memory drives, removable disc drives, etc., employing connection protocols such as Serial Advanced Technology Attachment (SATA), Integrated Drive Electronics (IDE), IEEE-1394, Universal Serial Bus (USB), fibre channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 405 may store a collection of program or database components, including, without limitation, a user interface 406, an operating system 407, a web browser 408 etc. In some embodiments, the computer system 400 may store user/application data, such as the data, variables, records, etc. as described in this invention. Such databases may be implemented as fault-tolerant, relational, scalable, secure databases such as Oracle or Sybase.

The operating system 407 may facilitate resource management and operation of the computer system 400. Examples of operating systems include, without limitation, APPLE® MACINTOSH® OS X®, UNIX®, UNIX-like system distributions (E.G., BERKELEY SOFTWARE DISTRIBUTION® (BSD), FREEBSD®, NETBSD®, OPENBSD, etc.), LINUX® DISTRIBUTIONS (E.G., RED HAT®, UBUNTU®, KUBUNTU®, etc.), IBM® OS/2®, MICROSOFT® WINDOWS® (XP®, VISTA®/7/8, 10 etc.), APPLE® IOS®, GOOGLE™ ANDROID™, BLACKBERRY® OS, or the like. The User interface 406 may facilitate display, execution, interaction, manipulation, or operation of program components through textual or graphical facilities. For example, user interfaces may provide computer interaction interface elements on a display system operatively connected to the computer system 400, such as cursors, icons, checkboxes, menus, scrollers, windows, widgets, etc. Graphical User Interfaces (GUIs) may be employed, including, without limitation, Apple® Macintosh® operating systems' Aqua®, IBM® OS/2®, Microsoft® Windows® (e.g., Aero, Metro, etc.), web interface libraries (e.g., ActiveX®, Java®, Javascript®, AJAX, HTML, Adobe® Flash®, etc.), or the like.

In some embodiments, the computer system 400 may implement the web browser 408 stored program components. The web browser 408 may be a hypertext viewing application, such as MICROSOFT® INTERNET EXPLORER®, GOOGLE™ CHROME™, MOZILLA® FIREFOX®, APPLE® SAFARI®, etc. Secure web browsing may be provided using Secure Hypertext Transport Protocol (HTTPS), Secure Sockets Layer (SSL), Transport Layer Security (TLS), etc. Web browsers 408 may utilize facilities such as AJAX, DHTML, ADOBE® FLASH®, JAVASCRIPT®, JAVA®, Application Programming Interfaces (APIs), etc. In some embodiments, the computer system 400 may implement a mail server stored program component. The mail server may be an Internet mail server such as Microsoft Exchange, or the like. The mail server may utilize facilities such as Active Server Pages (ASP), ACTIVEX®, ANSI® C++/C #, MICROSOFT®, .NET, CGI SCRIPTS, JAVA®, JAVASCRIPT®, PERL®, PHP, PYTHON®, WEBOBJECTS®, etc. The mail server may utilize communication protocols such as Internet Message Access Protocol (IMAP), Messaging Application Programming Interface (MAPI), MICROSOFT® exchange, Post Office Protocol (POP), Simple Mail Transfer Protocol (SMTP), or the like. In some embodiments, the computer system 400 may implement a mail client stored program component. The mail client may be a mail viewing application, such as APPLE® MAIL, MICROSOFT® ENTOURAGE®, MICROSOFT® OUTLOOK®, MOZILLA® THUNDERBIRD®, etc.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, non-volatile memory, hard drives, Compact Disc (CD) ROMs, Digital Video Disc (DVDs), flash drives, disks, and any other known physical storage media.

A description of an embodiment with several components in communication with each other does not imply that all such components are required. On the contrary a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The specification has described a method and a system for determining a potential supplier for a project. The illustrated steps are set out to explain the exemplary embodiments shown, and it should be anticipated that on-going technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

What is claimed is:

1. A method of determining a potential supplier for a project, the method comprising:
receiving, by a supplier determining system, input data related to a plurality of suppliers from one or more data sources associated with the supplier determining system, wherein the plurality of suppliers are related to a domain of a project;
extracting, by the supplier determining system, one or more entities and qualifying phrases corresponding to the one or more entities from the input data using a predefined ontology related to the domain;
generating, by the supplier determining system, one or more data models by annotating each of the qualifying phrases corresponding to the one or more entities with a label;
generating, by the supplier determining system, a weighted knowledge graph corresponding to each of the one or more data models that correlates the plurality of suppliers, the one or more entities and assessing attributes of the plurality of suppliers, wherein weightage in the weighted knowledge graph is determined based on each label to indicate a degree of correlation; and
recommending, by the supplier determining system, a potential supplier from the plurality of suppliers by ranking each of the plurality of suppliers based on one or more requirements queried by a user for the project and based on the degree of correlation inferred from each weighted knowledge graph.

2. The method as claimed in claim 1, wherein the assessing attributes of the plurality of suppliers are at least one of capabilities of the plurality of suppliers, experience of the plurality of suppliers, location of the plurality of suppliers, previous engagements of the plurality of suppliers, strengths, weaknesses and risks of the plurality of suppliers, market reputation of the plurality of suppliers, expertise of the plurality of suppliers, infrastructure details of the plurality of suppliers or team size of the plurality of suppliers.

3. The method as claimed in claim 1, wherein the one or more entities are extracted upon normalizing and structuring the input data using predefined techniques.

4. The method as claimed in claim 1, wherein the one or more data models are generated using machine learning techniques that are pre-trained based on the input data, and the one or more entities and the qualifying phrases extracted from the input data.

5. The method as claimed in claim 1, wherein the label comprises at least one of Excellent, Good, Satisfactory or Bad.

6. The method as claimed in claim 1 further comprises predicting, by the supplier determining system, progress of the plurality of suppliers based on the input data and the weighted knowledge graph corresponding to each of the plurality of suppliers.

7. The method as claimed in claim 1, wherein the ranking of the plurality of suppliers varies dynamically when the one or more requirements are modified by the user.

8. The method as claimed in claim 1, wherein the one or more data sources comprises at least one of internal data sources or external data sources.

9. The method as claimed in claim 1, wherein the input data related to the plurality of suppliers received from internal data sources is data stored within an organization developing the project, wherein the internal data sources comprises at least one of site visit reports, previous experience of working with the plurality of suppliers, feedback of employees on work quality of the plurality of suppliers or tenders received from the plurality of suppliers.

10. The method as claimed in claim 1, wherein the input data related to the plurality of suppliers received from external data sources is data obtained from outside an organization developing the project, wherein the external data sources comprises at least one of forums, articles, publications, online magazines and newspapers, and websites of the plurality of suppliers.

11. A supplier determining system for determining a potential supplier for a project, the supplier determining system comprising:
a processor; and
a memory communicatively coupled to the processor, wherein the memory stores the processor-executable instructions, which, on execution, causes the processor to:
receive input data related to a plurality of suppliers from one or more data sources associated with the supplier determining system, wherein the plurality of suppliers is related to a domain of a project;
extract one or more entities and qualifying phrases corresponding to the one or more entities from the input data using a predefined ontology related to the domain;
generate one or more data models by annotating each of the qualifying phrases corresponding to the one or more entities with a label;
generate a weighted knowledge graph corresponding to each of the one or more data models that correlates the plurality of suppliers, the one or more entities and assessing attributes of the plurality of suppliers, wherein weightage in the weighted knowledge graph is determined based on each label to indicate a degree of correlation; and
recommend a potential supplier from the plurality of suppliers by ranking each of the plurality of suppliers based on one or more requirements queried by a user for the project and based on the degree of correlation inferred from each weighted knowledge graph.

12. The supplier determining system as claimed in claim 11, wherein the assessing attributes of the plurality of suppliers are at least one of capabilities of the plurality of suppliers, experience of the plurality of suppliers, location of the plurality of suppliers, previous engagements of the plurality of suppliers, strengths, weaknesses and risks of the plurality of suppliers, market reputation of the plurality of suppliers, expertise of the plurality of suppliers, infrastructure details of the plurality of suppliers or team size of the plurality of suppliers.

13. The supplier determining system as claimed in claim 11, wherein the one or more entities are extracted upon normalizing and structuring the input data using predefined techniques.

14. The supplier determining system as claimed in claim 11, wherein the one or more data models are generated using machine learning techniques that are pre-trained based on the input data, and the one or more entities and the qualifying phrases extracted from the input data.

15. The supplier determining system as claimed in claim 11, wherein the processor is further configured to predict progress of the plurality of suppliers based on the input data and the weighted knowledge graph corresponding to each of the plurality of suppliers.

16. The supplier determining system as claimed in claim 11, wherein the ranking of the plurality of suppliers varies dynamically when the one or more requirements are modified by the user.

17. The supplier determining system as claimed in claim 11, wherein the one or more data sources comprises at least one of internal data sources or external data sources.

18. The supplier determining system as claimed in claim 11, wherein the input data related to the plurality of suppliers received from internal data sources is data stored within an organization developing the project, wherein the internal data sources comprises at least one of site visit reports, previous experience of working with the plurality of suppliers, feedback of employees on work quality of the plurality of suppliers or tenders received from the plurality of suppliers.

19. The supplier determining system as claimed in claim 11, wherein the input data related to the plurality of suppliers received from external data sources is data obtained from outside an organization developing the project, wherein the external data sources comprises at least one of forums, articles, publications, online magazines and newspapers, and websites of the plurality of suppliers.

20. A non-transitory computer readable medium including instructions stored thereon that when processed by at least one processor causes a supplier determining system to perform operations comprising:
receiving input data related to a plurality of suppliers from one or more data sources associated with the supplier determining system, wherein the plurality of suppliers are related to a domain of a project;
extracting one or more entities and qualifying phrases corresponding to the one or more entities from the input data using a predefined ontology related to the domain;
generating one or more data models by annotating each of the qualifying phrases corresponding to the one or more entities with a label;
generating a weighted knowledge graph corresponding to each of the one or more data models that correlates the plurality of suppliers, the one or more entities and assessing attributes of the plurality of suppliers, wherein weightage in the weighted knowledge graph is determined based on each label to indicate a degree of correlation; and
recommending a potential supplier from the plurality of suppliers by ranking each of the plurality of suppliers based on one or more requirements queried by a user for the project and based on the degree of correlation inferred from each weighted knowledge graph.
